(19) United States
(12) Patent Application Publication
(10) Pub. No.: US 2025/0032923 A1
(43) Pub. Date: Jan. 30, 2025

(54) INTERACTION IN A VIRTUAL ENVIRONMENT

(71) Applicant: Tencent Technology (Shenzhen) Company Limited, Shenzhen (CN)

(72) Inventor: Chennan ZHANG, Shenzhen (CN)

(73) Assignee: Tencent Technology (Shenzhen) Company Limited, Shenzhen (CN)

(21) Appl. No.: 18/913,981

(22) Filed: Oct. 11, 2024

Related U.S. Application Data
(63) Continuation of application No. PCT/CN2023/126195, filed on Oct. 24, 2023.

(30) Foreign Application Priority Data
Dec. 23, 2022 (CN) 202211673761.4

(51) Int. Cl. A63F 13/56

(52) U.S. Cl. CPC A63F 13/56

(57) ABSTRACT

In a method for interacting in a virtual environment, the virtual environment is displayed that includes a first area having an obscured visual state, an interactive object, and a virtual character controlled by a user. In response to a user input corresponding to an illumination action, a second area within the first area is modified to an unobscured visual state. Whether the interactive object is located within the second area is determined. An interaction state of the interactive object is changed from a first interaction state to a second interaction state based on the interactive object being determined to be located within the second area. The first interaction state and the second interaction state defining different interactions with the virtual character. Apparatus and non-transitory computer-readable storage medium counterpart embodiments are also contemplated.

### RELATED APPLICATIONS

The present application is a continuation of International Application No. PCT/CN2023/126195, filed on Oct. 24, 2023, which claims priority to Chinese Patent Application No. 202211673761.4, filed on Dec. 23, 2022. The entire disclosures of the prior applications are hereby incorporated by reference.

### FIELD OF THE TECHNOLOGY

Embodiments of this disclosure relate to the field of man-machine interaction, including interaction in a side-scrolling virtual environment.

### BACKGROUND OF THE DISCLOSURE

In a side-scrolling game in the related art, a user may control a main control virtual character to explore a side-scrolling virtual environment in the dark. Most areas of the side-scrolling virtual environment are displayed in a dark form, and only the side-scrolling virtual environment around the main control virtual character is displayed in a light form. As the main control virtual character moves, a display form of the side-scrolling virtual environment also correspondingly changes. The user needs to control the main control virtual character to explore the side-scrolling virtual environment and attack an enemy that moves out of the dark.

In the side-scrolling game in the related art, a virtual object (an enemy, a terrain, a mechanism, or the like) in the side-scrolling virtual environment has only a single status. For example, the enemy only moves to and attacks the main control virtual character, and a manner of interaction between the virtual object and the main control virtual character is undiversified.

### SUMMARY

This disclosure includes a method, apparatus, and a non-transitory computer-readable storage medium for interaction in a side-scrolling virtual environment, which can enrich a manner of interaction between a virtual object and a main control virtual character based on a display form of a side-scrolling virtual environment. Examples of technical solutions in the embodiments of this disclosure may be implemented as follows:

An aspect of this disclosure provides a method for interacting in a virtual environment. The virtual environment is displayed and includes a first area having an obscured visual state, an interactive object, and a virtual character controlled by a user. In response to a user input corresponding to an illumination action, a second area within the first area is modified to an unobscured visual state. Whether the interactive object is located within the second area is determined. An interaction state of the interactive object is changed from a first interaction state to a second interaction state based on the interactive object being determined to be located within the second area. The first interaction state and the second interaction state define different interactions with the virtual character.

An aspect of this disclosure provides an apparatus, including processing circuitry. The processing circuitry is configured to display a virtual environment that includes a first area having an obscured visual state, an interactive object, and a virtual character controlled by a user. In response to a user input corresponding to an illumination action, the processing circuitry is configured to modify a second area within the first area to an unobscured visual state. The processing circuitry is configured to change an interaction state of the interactive object from a first interaction state to a second interaction state based on the interactive object being determined to be located within the second area, the first interaction state and the second interaction state defining different interactions with the virtual character.

An aspect of this disclosure provides a non-transitory computer-readable storage medium storing instructions which when executed by a processor cause the processor to perform any of the methods of this disclosure.

Technical solutions provided in the embodiments of this disclosure can have the following beneficial effects:
A blocked area in the side-scrolling virtual environment is changed by using the lighting operation, so that the display form of the side-scrolling virtual environment is changed, thereby affecting the interaction status of the environment-sensitive object in the side-scrolling virtual environment. Because the environment-sensitive object is sensitive to the environment, when the blocking status of the location of the environment-sensitive object changes, the interaction status of the environment-sensitive object also correspondingly changes, so that the environment-sensitive object has a variety of interaction states of interacting with the main control virtual character, which enriches the manner of interaction between the environment-sensitive object and the main control virtual character, improves game experience, and enhances strategy of a side-scrolling game.

### BRIEF DESCRIPTION OF THE DRAWINGS

FIG. 1 is a structural block diagram of a computer system according to an embodiment.

FIG. 2 is a flowchart of an interaction method based on a side-scrolling virtual environment according to an embodiment.

FIG. 3 is a flowchart of an interaction method based on a side-scrolling virtual environment according to an embodiment.

FIG. 4 is an example of a side-scrolling virtual environment picture according to an embodiment.

FIG. 5 is an example of a side-scrolling virtual environment picture according to an embodiment.

FIG. 6 is an example of a side-scrolling virtual environment picture according to an embodiment.

FIG. 7 is an example of a side-scrolling virtual environment picture according to another embodiment.

FIG. 8 is an example of a side-scrolling virtual environment picture according to another embodiment.

FIG. 9 is an example of a side-scrolling virtual environment picture according to another embodiment.

FIG. 10 is an example of a side-scrolling virtual environment picture according to another embodiment.

FIG. 11 is an example of a side-scrolling virtual environment picture according to another embodiment.

FIG. 12 is an example of a side-scrolling virtual environment picture according to another embodiment.

FIG. 13 is a flowchart of an interaction method based on a side-scrolling virtual environment according to another embodiment.

FIG. 14 is an example of a side-scrolling virtual environment picture according to another embodiment.

FIG. 15 is a flowchart of an interaction method based on a side-scrolling virtual environment according to another embodiment.

FIG. 16 is an example of a side-scrolling virtual environment picture according to another embodiment.

FIG. 17 is an example of a side-scrolling virtual environment picture according to another embodiment.

FIG. 18 is a flowchart of an interaction method based on a side-scrolling virtual environment according to another embodiment.

FIG. 19 is a schematic diagram of a process of transforming three-dimensional space into a two-dimensional image according to an embodiment of this disclosure.

FIG. 20 is a structural block diagram of an interaction apparatus based on a side-scrolling virtual environment according to an embodiment of this disclosure.

FIG. 21 is a schematic structural diagram of a computer device according to an embodiment of this disclosure.

### DESCRIPTION OF EMBODIMENTS

First, examples of terms involved in the embodiments of this disclosure are briefly introduced. The descriptions of the terms are provided as examples only and are not intended to limit the scope of the disclosure.

Side-scrolling game: It is a game in which a movement route of a game character is controlled on a movement plane. In all pictures or most pictures in the side-scrolling game, all the movement routes of the game character (a main control virtual character) are along a horizontal direction. According to contents, the side-scrolling game may be divided into games such as side-scrolling clearance, side-scrolling adventure, side-scrolling competition, and side-scrolling strategy; and according to technologies, the side-scrolling game may be divided into a two-dimensional (2D) side-scrolling game and a three-dimensional (3D) side-scrolling game.

Side-scrolling virtual environment: It is a virtual environment displayed (or provided) when an application program runs on a terminal. The side-scrolling virtual environment may be a simulated environment of a real world, or may be a semi-simulated and semi-fictional environment, or may be a fictional environment. The side-scrolling virtual environment may be any one of a two-dimensional virtual environment, a 2.5-dimensional virtual environment, and a three-dimensional virtual environment. This is not limited in this disclosure. A description is made by using an example in which the virtual environment is a three-dimensional virtual environment in the following embodiments. When the side-scrolling virtual environment is a three-dimensional virtual environment, a movement plane on which a game character can move is any plane perpendicular to a horizontal plane and parallel to a photographing plane (an imaging plane when a camera captures the side-scrolling virtual environment) in the three-dimensional virtual environment. The game character can move only on the movement plane, and cannot move to another spatial location in the three-dimensional virtual environment.

In some embodiments, the side-scrolling virtual environment may provide a battle environment of a virtual object (a main control virtual character controlled by a user or a virtual object controlled by a computer). For example, in the side-scrolling game, one or two virtual objects play in a single-round battle in the side-scrolling virtual environment. The virtual object escapes an attack performed by an enemy unit and dangers (such as a poison gas area, a swamp, an anti-aircraft gun, and aircraft bombing) in the side-scrolling virtual environment to survive in the side-scrolling virtual environment. When a hit point value of the virtual object in the side-scrolling virtual environment is zero, life of the virtual object in the side-scrolling virtual environment ends, and a final virtual object successfully passing a route in a level wins. Each client may control one or more virtual objects in the side-scrolling virtual environment. In some embodiments, arena modes of the battle may include a single-player battle mode, a two-player team battle mode, or a multi-player team battle mode. The battle mode is not limited in the embodiments.

For example, a side-scrolling virtual environment picture is a picture in which the side-scrolling virtual environment is observed from a landscape perspective. For example, the side-scrolling virtual environment picture is a picture obtained by observing a main control virtual character (with the main control virtual character as a photographing center) from a perspective perpendicular to a horizontal plane of the side-scrolling virtual environment and perpendicular to a movement plane on which a virtual object moves in the side-scrolling virtual environment.

Virtual object: It is a movable object in a side-scrolling virtual environment. The movable object may be a virtual character, a virtual animal, a cartoon character, a virtual plant, a virtual mechanism, or the like, for example, a character, an animal, a plant, or a mechanism displayed in a three-dimensional side-scrolling virtual environment. In some embodiments, the virtual object is a three-dimensional model created based on an animation technology. Each virtual object has a shape and size in the three-dimensional side-scrolling virtual environment, and occupies some space in the three-dimensional side-scrolling virtual environment. In some embodiments, the virtual object includes a virtual character (a main control virtual character) controlled by a client/user, and a virtual character/virtual object controlled by a computer program.

In some embodiments, the virtual object may be divided into different character types based on an attribute value or a skill of the virtual object. For example, if a target virtual object has a remote-output-type skill, a corresponding character type may be a shooter; and if the target virtual object has an auxiliary-type skill, the corresponding character type may be an auxiliary. In some embodiments, a same virtual object may correspond to a plurality of character types.

Virtual item: It is an item that can be used by a virtual object in a side-scrolling virtual environment, and includes an item (a match, a brazier, a lamp bulb, or the like) that can change a display form of the side-scrolling virtual environment, a supply item such as a bullet, a defensive item such as a shield, an armor, or an armored vehicle, a virtual item such as a virtual beam or a virtual shock wave shown through a hand when being configured to cast a skill by the virtual object, a body part such as a hand or a leg of the virtual object, and a virtual item that can change an attribute value of another virtual object and include a long-distance virtual item such as a pistol, a rifle, or a sniper rifle, a short-distance virtual item such as a dagger, a knife, a sword, or a rope, and a throwing type virtual item such as a flying axe, a flying knife, a grenade, a flash bomb, a smoke bomb, or a throwing bulb.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

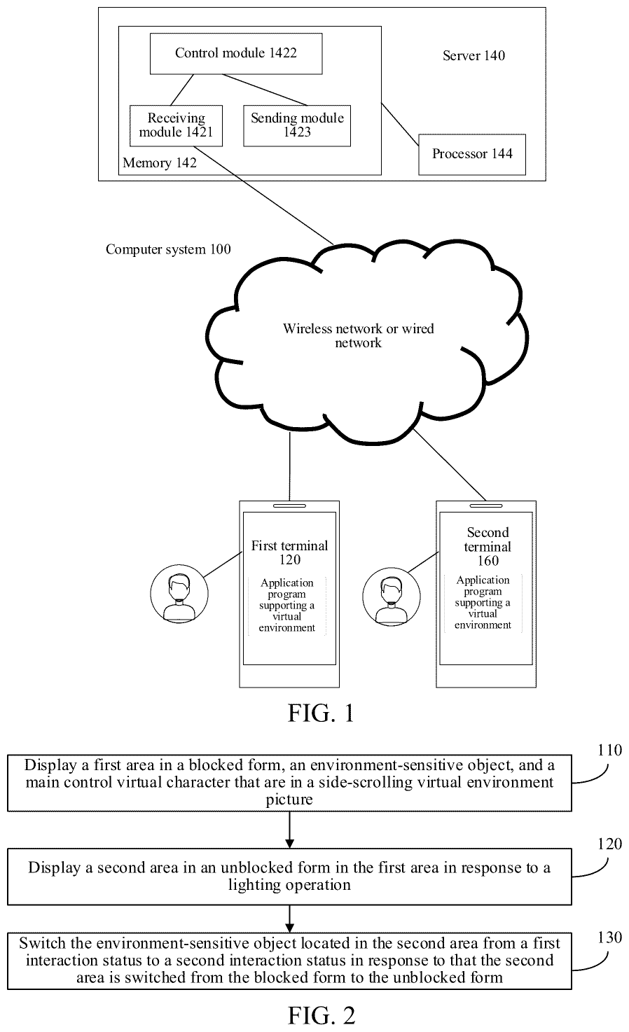

FIG. 1 is a structural block diagram of a computer system according to an embodiment of this disclosure. The computer system 100 includes: a first terminal 120, a server 140, and a second terminal 160.

An application program supporting a side-scrolling virtual environment is installed and run in the first terminal 120. The application program may be any one of a three-dimensional map application, side-scrolling shooting, side-scrolling adventure, side-scrolling clearance, side-scrolling strategy, a virtual reality (VR) application program, and an augmented reality (AR) program. The first terminal 120 is a terminal used by a first user, and the first user uses the first terminal 120 to control a first virtual object in the side-scrolling virtual environment to move. A movement includes, but is not limited to at least one of adjusting a body gesture, walking, running, jumping, riding, driving, aiming, picking, using a throwing type item, and attacking another virtual object. For example, the first virtual object is a first virtual character, such as a simulated character object or a cartoon character object. For example, the first user controls, by using a user interface (UI) control in a side-scrolling virtual environment picture, the first virtual object to move.

The first terminal 120 is connected to the server 140 by using a wireless network or a wired network.

The server 140 includes at least one of one server, a plurality of servers, a cloud computing platform, and a virtualization center. For example, the server 140 includes a processor 144 and a memory 142. The memory 142 further includes a receiving module 1421, a control module 1422, and a sending module 1423. The receiving module 1421 is configured to receive a request, for example, an item use request, sent by a client. The control module 1422 is configured to control rendering of the side-scrolling virtual environment picture. The sending module 1423 is configured to send a response to the client, for example, send the side-scrolling virtual environment picture to the client. The server 140 is configured to provide a backend service for the application program supporting the side-scrolling virtual environment. In some embodiments, the server 140 is responsible for primary computing work, and the first terminal 120 and the second terminal 160 are responsible for secondary computing work; or the server 140 is responsible for secondary computing work, and the first terminal 120 and the second terminal 160 are responsible for primary computing work; or the server 140, the first terminal 120, and the second terminal 160 perform collaborative computing by using a distributed computing architecture among each other.

An application program supporting the side-scrolling virtual environment is installed and run in the second terminal 160. The application program may be any one of a three-dimensional map application, side-scrolling shooting, side-scrolling adventure, side-scrolling clearance, side-scrolling strategy, a virtual reality application program, and an augmented reality program. The second terminal 160 is a terminal used by a second user, and the second user uses the second terminal 160 to control a second virtual character in the side-scrolling virtual environment to move. A movement includes, but is not limited to, at least one of adjusting a body gesture, walking, running, jumping, riding, driving, aiming, picking, using a throwing type item, and attacking another virtual object. For example, the second virtual object is a second virtual character, such as a simulated character object or a cartoon character object.

In some embodiments, the first virtual object and the second virtual object are located in the same side-scrolling virtual environment. In some embodiments, the first virtual object and the second virtual object may belong to the same team, the same organization, or the same camp, have a friend relationship with each other, or have a temporary communication permission. In some embodiments, the first virtual object and the second virtual object may belong to different camps, different teams, or different organizations, or have a hostile relationship with each other.

In some embodiments, the applications installed on the first terminal 120 and the second terminal 160 are the same, or the applications installed on the two terminals are the same type of applications on different operating system platforms (Android system or iOS system). The first terminal 120 may be one of a plurality of terminals, and the second terminal 160 may be one of a plurality of terminals. In this embodiment, only the first terminal 120 and the second terminal 160 are configured for description. The first terminal 120 and the second terminal 160 are of the same device type or of different device types. The device type includes at least one of a smartphone, a tablet computer, an e-book reader, a Moving Picture Experts Group Audio Layer III (MP3) player, a Moving Picture Experts Group Audio Layer IV (MP4) player, a laptop, and a desktop computer. The following embodiment is described by using an example in which the terminal includes a smartphone.

A person skilled in the art may learn that there may be more or fewer terminals. For example, there may be only one terminal, or there may be dozens of or hundreds of terminals or more. A quantity of terminals and a device type of the terminal are not limited in this embodiment of this disclosure.

FIG. 2 is a flowchart of an interaction method based on a side-scrolling virtual environment according to an embodiment of this disclosure. This embodiment is performed, for example, by a computer device. The computer device includes the terminal (the first terminal or the second terminal)/the client shown in FIG. 1. The method includes the following operations.

Operation 110: Display a first area in a blocked form (or obscured form), an environment-sensitive object, and a main control virtual character that are in a side-scrolling virtual environment picture. For example, the virtual environment is displayed that includes a first area having an obscured visual state, an interactive object, and a virtual character controlled by a user.

An interaction status of the environment-sensitive object varies with a blocking status of a location of the environment-sensitive object.

The interaction status is a status of interaction between the environment-sensitive object and the main control virtual character.

The blocked form is configured for indicating that a shade-special effect is added to the first area in a side-scrolling virtual environment picture obtained through rendering.

In some embodiments, the blocked form includes at least one of a dark form, a sand storm form, a fog form, a rain form, a haze form, and a snow form, but is not limited to thereto. This is not specifically limited in the embodiments of this disclosure. The descriptions of the blocked forms are provided as examples only and are not intended to limit the scope of the disclosure.

In an example, the dark form means that a black mask is added to the first area in the side-scrolling virtual environment picture obtained through rendering. In this case, a sight of a user is affected by darkness.

In an example, the sand storm form means that a sand storm-like mask is added to the first area in the side-scrolling virtual environment picture obtained through rendering, to simulate a sand storm scene. In this case, the sight of the user is affected by a sand storm.

In an example, the fog form means that a fog-like mask is added to the first area in the side-scrolling virtual environment picture obtained through rendering, to simulate a fog scene. In this case, the sight of the user is affected by fog.

In an example, the rain form means that a rain-like mask is added to the first area in the side-scrolling virtual environment picture obtained through rendering, to simulate a heavy rain scene. In this case, the sight of the user is affected by rain.

In an example, the haze form means that a haze-like mask is added to the first area in the side-scrolling virtual environment picture obtained through rendering, to simulate a haze scene. In this case, the sight of the user is affected by a haze.

In an example, the snow form means that a snow-like mask is added to the first area in the side-scrolling virtual environment picture obtained through rendering, to simulate a heavy snow scene. In this case, the sight of the user is affected by snow.

Operation 120: Display a second area in an unblocked form or unobscured form in the first area in response to a lighting operation. For example, in response to a user input corresponding to an illumination action, a second area within the first area is modified to an unobscured visual state.

The unblocked form is configured for indicating that the shade-special effect is not added to the second area in the side-scrolling virtual environment picture obtained through rendering.

In some embodiments, the unblocked form includes at least one of a light form and a shine form, but is not limited to thereto. This is not specifically limited in the embodiments of this disclosure. The descriptions of the unblocked forms are provided as examples only and are not intended to limit the scope of the disclosure.

In an example, the light form means excavating a hole at a corresponding location on a dark mask in the side-scrolling virtual environment, so that a location of the second area is not covered by the dark mask. In this way, the second area in the side-scrolling virtual environment picture obtained through rendering is displayed in the light form.

In an example, the shine form means excavating a hole at a corresponding location on at least one of the sand storm-like mask, the fog-like mask, the rain-like mask, the haze-like mask, and the snow-like mask in the side-scrolling virtual environment, so that the location of the second area is not covered by the mask. In this way, the second area in the side-scrolling virtual environment picture obtained through rendering is displayed in the shine form.

The lighting operation includes at least one of that the main control virtual character triggers an item in the side-scrolling virtual environment to change a form of the second area and that the main control virtual character casts a skill to change the form of the second area, but is not limited to thereto. This is not specifically limited in the embodiments of this disclosure.

Operation 130: Switch the environment-sensitive object located in the second area from a first interaction status to a second interaction status in response to that the second area is switched from the blocked form to the unblocked form. For example, an interaction state of the interactive object is changed from a first interaction state to a second interaction state based on the interactive object being determined to be located within the second area. In an example, the first interaction state and the second interaction state defining different interactions with the virtual character.

When the blocked form of the second area changes, the interaction status of the environment-sensitive object located in the second area also correspondingly changes. The first interaction status is an interaction status of the environment-sensitive object located in an environment in the blocked form, and the second interaction status is an interaction status of the environment-sensitive object located in an environment in the unblocked form.

In some embodiments, the environment-sensitive object includes at least one of a sand storm-sensitive object, a fog-sensitive object, a rain-sensitive object, a haze-sensitive object, and a snow-sensitive object, but is not limited thereto.

A manner of determining whether the environment-sensitive object is located in the second area may be: determining whether a center point of the environment-sensitive object is located in the second area, or determining whether at least one pixel point of the environment-sensitive object is located in the second area. If the center point or the at least one pixel point is located in the second area, it indicates that the environment-sensitive object is located in the second area, and the interaction status of the environment-sensitive object is changed.

In conclusion, according to the method provided in this embodiment of this disclosure, a blocked area in the side-scrolling virtual environment is changed by using the lighting operation, so that the display form of the side-scrolling virtual environment is changed, thereby affecting the interaction status of the environment-sensitive object in the side-scrolling virtual environment. Because the environment-sensitive object is sensitive to the environment, when the blocking status of the location of the environment-sensitive object changes, the interaction status of the environment-sensitive object also correspondingly changes, so that the environment-sensitive object has a variety of interaction states of interacting with the main control virtual character, which enriches the manner of interaction between the environment-sensitive object and the main control virtual character, improves game experience, and enhances strategy of a side-scrolling game.

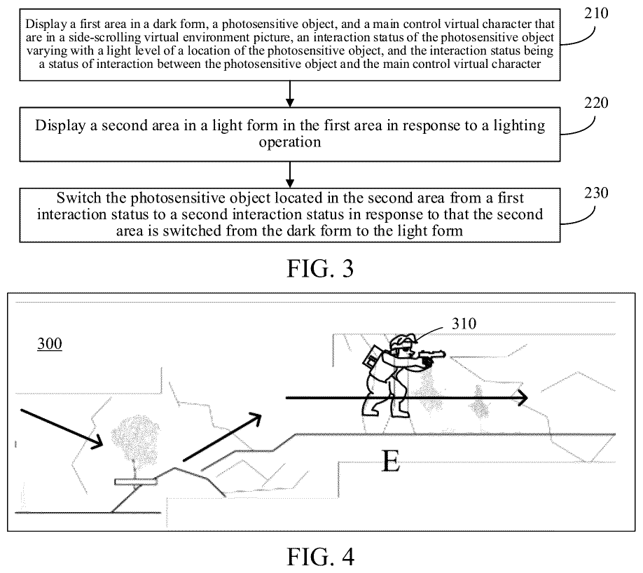

An example in which the blocked form is the dark form, the unblocked form is the light form, and the environment-sensitive object is the photosensitive object is used. FIG. 3 is a flowchart of an interaction method based on a side-scrolling virtual environment according to an embodiment of this disclosure. This embodiment is performed by a computer device, for example. The computer device includes the terminal (the first terminal or the second terminal)/the client shown in FIG. 1. The method includes the following operations.

Operation 210: Display a first area in a dark form, a photosensitive object, and a main control virtual character that are in a side-scrolling virtual environment picture, an interaction status of the photosensitive object varying with a light level of a location of the photosensitive object, and the interaction status being a status of interaction between the photosensitive object and the main control virtual character. For example, the virtual environment is displayed that includes a first area having an obscured visual state, an interactive object, and a virtual character controlled by a user. In an example, the first interaction state and the second interaction state defining different interactions with the virtual character.

The side-scrolling virtual environment picture is a picture obtained by photographing the side-scrolling virtual environment. The side-scrolling virtual environment is a three-dimensional virtual environment, and the side-scrolling virtual environment includes the photosensitive object and the main control virtual character. Both the photosensitive object and the main control virtual character also have three-dimensional models. In some embodiments, a three-dimensional side-scrolling virtual environment is obtained through three-dimensional modeling, and then a two-dimensional side-scrolling virtual environment picture is obtained through photographing the side-scrolling virtual environment by using a camera.

In some embodiments, movement space of the main control virtual character is limited in the side-scrolling virtual environment. The main control virtual character can only move along a preset movement line. The movement line is referred to as a moving line for short. In an example, the moving line is in a horizontal direction. In some cases, the moving line may be on two levels (above and below), or on three levels (above, middle, and below), for example, a scenario in which a bridge or a high platform exists. In some cases, the moving line may be oblique or vertical, for example, a scenario in which a slope or a cliff exists. In some embodiments, the moving line may alternatively be a plane on which the moving line is located. The plane is perpendicular to a horizontal plane of the side-scrolling virtual environment.

In an embodiment, FIG. 4 is a schematic diagram of a side-scrolling virtual environment picture. A side-scrolling virtual environment picture 300 includes a main control virtual character 310 and a first moving line. The first moving line is shown by arrows in the figure, and E is a point of the main control virtual character 310 on the first moving line. The arrows and the character in FIG. 4 play only an indicating role, and are not displayed in the virtual environment picture.

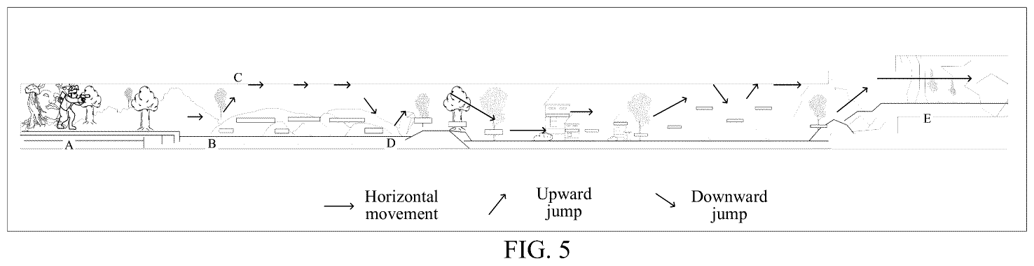

In an embodiment, FIG. 5 is a schematic diagram of a complete moving line in a level. The complete moving line includes at least one moving line. For example, FIG. 5 shows a complete moving line in a level, and the complete moving line includes at least one of a moving line for a main control virtual character to move in a horizontal direction, a moving line for the main control virtual character to jump upward, and a moving line for the main control virtual character to jump downward. Arrows and characters in FIG. 5 play only an indicating role, and are not displayed in a level picture.

The moving line may alternatively be referred to as a movable path of the main control virtual character in a side-scrolling virtual environment. In this embodiment of this disclosure, a change in an interaction status of a photosensitive object may affect the moving line (a movement path) of the main control virtual character in the side-scrolling virtual environment.

The main control virtual character is a virtual object controlled by a client/user. The main control virtual character may be a virtual character, a virtual animal, or the like. The main control virtual character has a three-dimensional model in the side-scrolling virtual environment, but the main control virtual character can move only along a two-dimensional moving line in the side-scrolling virtual environment. For example, the main control virtual character can only move forward, backward, upward, and downward, and cannot move left (an outward direction perpendicular to a side-scrolling virtual environment picture) or right (an inward direction perpendicular to the side-scrolling virtual environment picture).

The side-scrolling virtual environment in this embodiment of this disclosure is displayed in a dark form, and may be configured for simulating a scene of a dark exploration type. For example, the side-scrolling virtual environment may be a dark cave scene or a night scene. Most areas in the side-scrolling virtual environment are displayed in the dark form, and only a few areas are illuminated due to a light source with the environment, a light source triggered by the main control virtual character, a light source with the main control virtual character, and the like, and are displayed in a light form.

For example, as shown in FIG. 6, a side-scrolling virtual environment 401 in this embodiment of this disclosure is normally displayed in the dark form. In the dark, a user may vaguely see some outlines of the side-scrolling virtual environment.

In some embodiments, an implementation of displaying the side-scrolling virtual environment in the dark form may be: placing a trigger of a dark mask in a three-dimensional virtual environment of the side-scrolling virtual environment, and generating a dark screen filter after the main control virtual character enters the trigger. In some embodiments, when the side-scrolling virtual environment picture is rendered, if the rendering is performed through the dark mask, a side-scrolling virtual environment picture covered by the dark may be obtained.

The photosensitive object is a virtual object sensitive to light/dark, and may sense a change in a light level of an environment and correspondingly react. The photosensitive object may be a living being (for example, a virtual animal, a virtual plant, a virtual character, or a virtual enemy). The photosensitive object may alternatively be a machine, a building, a device, or the like, for example, a photosensitive sensor or a device used by charging through solar energy.

The photosensitive object may interact with the main control virtual character. For example, an interaction status of the main control virtual character may include at least one of a battle state, a non-battle state/vertigo state, a state of providing the moving line, and a state of blocking the moving line. A photosensitive object in the battle state may automatically attack the main control virtual object, a photosensitive object in the non-battle state/vertigo state does not attack the main control virtual object, a photosensitive object in the state of providing the moving line may provide a new moving line/movement path for the main control virtual character, and a photosensitive object in the state of blocking the moving line may block the moving line/movement path of the main control virtual character.

The photosensitive object in environments with different light levels may have different interaction states. For example, the photosensitive object may switch a corresponding interaction status based on a display form (the dark form/light form) of a location of the photosensitive object. In this case, the photosensitive object may have two interaction states. Alternatively, the photosensitive object may switch a corresponding interaction status based on a light level of a location of the photosensitive object. In this case, the photosensitive object may have a variety of interaction states.

For example, the photosensitive object in environments with different light levels correspondingly has different interaction states.

In some embodiments, the first area is a dark area in the side-scrolling virtual environment.

Operation 220: Display a second area in a light form in the first area in response to a lighting operation. For example, in response to a user input corresponding to an illumination action, a second area within the first area is modified to an unobscured visual state.

The lighting operation is configured for lighting up a partial area (the second area) in the dark area/first area. The first area includes the second area, or the first area includes a part of the second area.

When the user controls the main control virtual character to light up the second area, the second area is displayed in the light form. In some embodiments, an area displayed in the light form is not covered by the dark mask during rendering.

In some embodiments, the side-scrolling virtual environment includes a lighting item that may be lit, or the main control virtual character carries a lighting item that may illuminate the side-scrolling virtual environment, or some areas in the side-scrolling virtual environment have light (which may be blocked by a light-blocking object). After being lit, the lighting item may illuminate a partial area of the side-scrolling virtual environment. Alternatively, after the light-blocking object is destroyed, light in the side-scrolling virtual environment may be restored.

For example, interactive objects, such as a first static lighting item, a second static lighting item, a portable lighting item, and a light-emitting object carried in the side-scrolling virtual environment, that need to emit light in the dark, may be configured from a script, and a light range of these interactive objects during lighting is configured in the script. In addition, to ensure nature of an art effect, a material and a light-emitting curve of a light-emitting area may be further configured in the script, to make a light-emitting effect more natural.

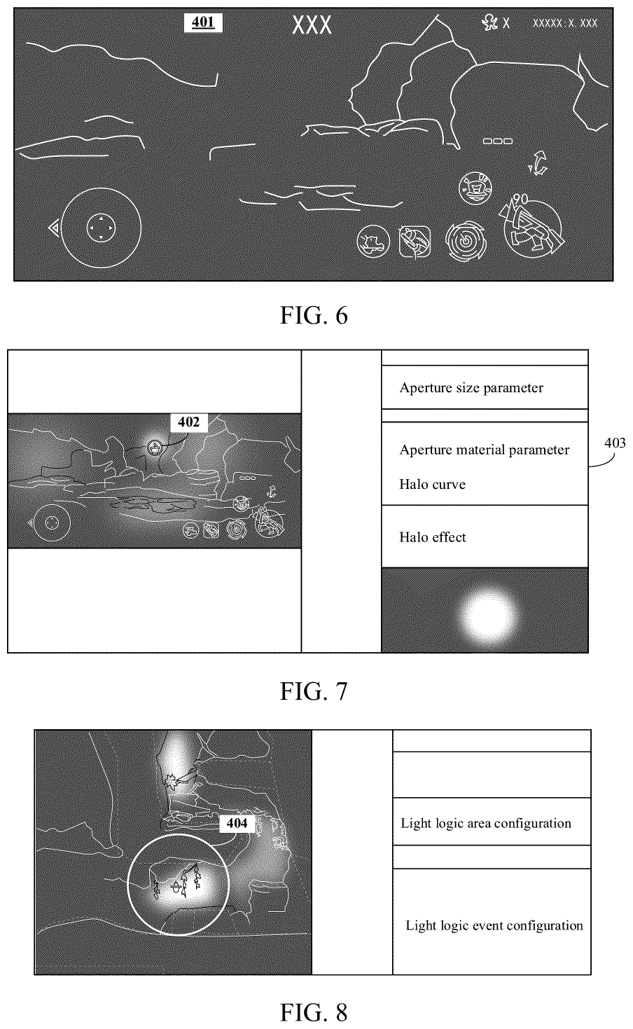

For example, as shown in FIG. 7, the side-scrolling virtual environment includes a torch 402, and after the torch 402 is lit, related configurations such as an aperture size parameter (a radius), an aperture material parameter, a halo curve, and a halo effect may be configured in a script 403 corresponding to the torch 402.

Operation 230: Switch the photosensitive object located in the second area from a first interaction status to a second interaction status in response to that the second area is switched from the dark form to the light form. For example, in response to the second area changing from the non-illuminated state to the illuminated state, the light-sensitive object is switched from the first interaction state to the second interaction state.

When a light level of the second area changes, the interaction status of the photosensitive object located in the second area also correspondingly changes. The first interaction status is an interaction status of the photosensitive object located in an environment in the dark form, and the second interaction status is an interaction status of the photosensitive object located in an environment in the light form.

A manner of determining whether the photosensitive object is located in the second area may be: determining whether a center point of the photosensitive object is located in the second area, or determining whether at least one pixel point of the photosensitive object is located in the second area. If the center point or the at least one pixel point is located in the second area, it indicates that the photosensitive object is located in the second area, a lighting event of the photosensitive object is triggered, and the interaction status of the photosensitive object is changed.

As shown in FIG. 8, a logic range 404 in which light actually takes effect, and a logic event may be configured for the light-emitting object. When a target (the photosensitive object) is located within the logic range 404 in which the target is lit, the lighting event is received, and the interaction status of the photosensitive object is triggered to be changed.

A manner of interaction between the photosensitive object in the first interaction status and the main control virtual character is different from a manner of interaction between the photosensitive object in the second interaction status and the main control virtual character. For example, the first interaction status may be one of the battle state, the non-battle state/vertigo state, the state of providing the moving line, and the state of blocking the moving line. The second interaction status may be an interaction status different from the first interaction status in the battle state, the non-battle state/vertigo state, the state of providing the moving line, and the state of blocking the moving line.

In some embodiments, a difference between the first interaction status and the second interaction status may alternatively be a difference of a degree of interaction in a same interaction status. For example, both the first interaction status and the second interaction status are attack states, but an attack speed of the second interaction status is lower than that of the first interaction status. Alternatively, both the first interaction status and the second interaction status are states of providing moving lines, but the moving lines provided by the first interaction status and the second interaction status are different.

In some embodiments, the photosensitive object located in the second area is switched from the second interaction status to the first interaction status in response to that the second area is switched from the light form to the dark form. In other words, when the location of the photosensitive object is changed to be in the dark form again, the photosensitive object returns to be in the first interaction status corresponding to the dark form again.

In some embodiments, a method of displaying the second area in the light form is: excavating a hole at a corresponding location on the dark mask in the three-dimensional side-scrolling virtual environment, so that a location of the second area is not covered by the dark mask. In this way, the second area in a side-scrolling virtual environment picture obtained through rendering is displayed in the light form.

For example, an illumination parameter of a light source corresponding to the lighting operation is obtained in response to the lighting operation. The illumination parameter includes at least one of a center location of the light source, a corresponding location of the light source on the dark mask, a lighting radius/aperture size of the light source, an aperture material of the light source, a halo effect of the light source, and a halo curve of the light source. A hole is correspondingly excavated on the dark mask based on the illumination parameter of the light source, so that the excavated hole matches the aperture size. Then, the three-dimensional side-scrolling virtual environment is rendered. Because the hole is excavated at the location corresponding to the second area on the dark mask, the second area in the side-scrolling virtual environment picture obtained through rendering is displayed in the light form.

In conclusion, according to the method provided in this embodiment of this disclosure, the dark area in the side-scrolling virtual environment is lit up by using the lighting operation, so that the display form of the side-scrolling virtual environment is changed, thereby affecting the interaction status of the photosensitive object in the side-scrolling virtual environment. Because the photosensitive object is sensitive to light, when a light display form of the location of the photosensitive object changes, the interaction status of the photosensitive object also correspondingly changes, so that the photosensitive object has a variety of interaction states of interacting with the main control virtual character, which enriches the manner of interaction between the photosensitive object and the main control virtual character, improves game experience, and enhances strategy of a side-scrolling game.

Based on the embodiment shown in FIG. 2, this embodiment of this disclosure provides a plurality of methods for lighting up a partial area in the side-scrolling virtual environment. To be specific, operation 220 may be replaced with at least one of the following manners.

Manner 1: The side-scrolling virtual environment picture further includes a first static lighting item; and the first static lighting item is lit to illuminate the second area in response to that a distance between the main control virtual character and the first static lighting item is less than a first threshold, the second area being determined based on a location of the first static lighting item and a lighting radius of the first static lighting item, where the first static lighting item is a short-time illumination item, and illumination duration of the first static lighting item after being lit is first duration.

The first static lighting item is a lighting item fixedly arranged in the side-scrolling virtual environment, in other words, the main control virtual character cannot change the location of the first static lighting item in the side-scrolling virtual environment.

The first static lighting item is a lighting item that continuously performs illumination for only a period of time after being lit, and the first static lighting item is automatically extinguished after the period of time. To be specific, lighting duration of the first static lighting item is timed in response to that the first static lighting item is lit; and the first static lighting item is controlled to be extinguished and the second area is re-displayed in the dark form in response to that the lighting duration reaches the first duration.

A manner for lighting the first static lighting item may be at least one of that the main control virtual character approaches the first static lighting item; the first static lighting item is tapped; the main control virtual character touches the first static lighting item; and the main control virtual character attacks the first static lighting item.

For example, the first static lighting item may be a torch. The torch is conventionally in an extinguished state, and the main control virtual character needs to interact with the torch. After the interaction, a light area is generated around the torch for 5 seconds, and the torch is extinguished in 5 seconds.

As shown in FIG. 9(1), a torch 405 is arranged in the side-scrolling virtual environment. The torch 405 in FIG. 9(1) is in an unlit state. After the main control virtual character lights the torch 405, a side-scrolling virtual environment picture shown in FIG. 9(2) is displayed, and a light area, namely, the second area displayed in the light form, is generated near the torch 405.

In some embodiments, the first static lighting item may further be a light bulb, an oil lamp, a firefly, a torch, or the like.

Manner 2: The side-scrolling virtual environment picture further includes a second static lighting item; and the second static lighting item is lit to illuminate the second area in response to that a distance between the main control virtual character and the second static lighting item is less than a second threshold, the second area being determined based on a location of the second static lighting item and a lighting radius of the second static lighting item, where the second static lighting item is a permanent illumination item, and the second static lighting item is not extinguished after being lit.

The second static lighting item is a lighting item fixedly arranged in the side-scrolling virtual environment, in other words, the main control virtual character cannot change the location of the second static lighting item in the side-scrolling virtual environment.

The second static lighting item is a lighting item that continuously performs illumination after being lit. In other words, the second static lighting item is not extinguished after being lit.

A manner for lighting the second static lighting item may be at least one of that the main control virtual character approaches the second static lighting item; the second static lighting item is tapped; the main control virtual character touches the second static lighting item; and the main control virtual character attacks the second static lighting item.

For example, the second static lighting item may be a brazier. The brazier is conventionally in an extinguished state, and the main control virtual character needs to interact with the brazier. After the interaction, the brazier permanently illuminates the surroundings, and a range is greater than that of the torch. A design purpose is to function as an archive point of a safe area. After a main control virtual character clears an area to reach the brazier, the main control virtual character may interact with the brazier. An appearance frequency of the brazier is much lower than that of the torch.

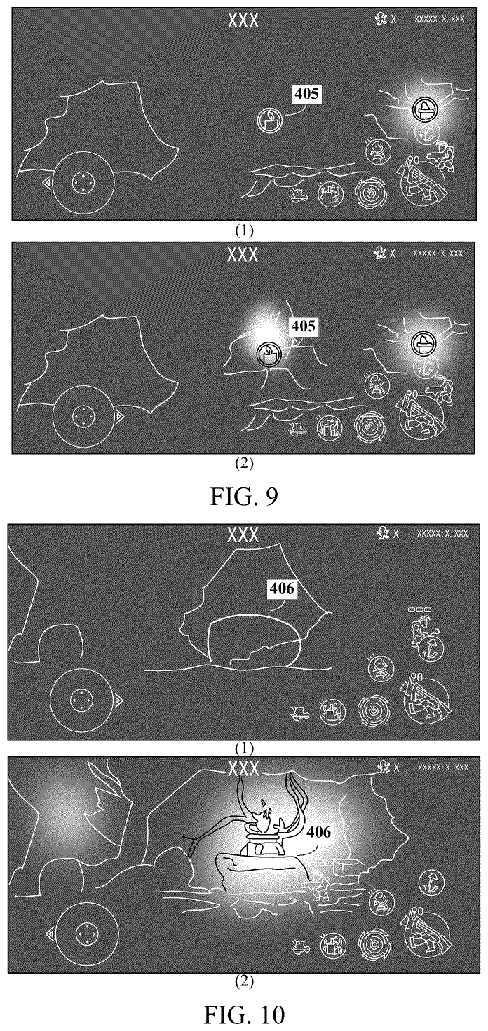

As shown in FIG. 10(1), a brazier 406 is arranged in the side-scrolling virtual environment. The brazier 406 in FIG. 10(1) is in an unlit state. After the main control virtual character lights the brazier 406, a side-scrolling virtual environment picture shown in FIG. 10(2) is displayed, and a light area, namely, the second area displayed in the light form, is generated near the brazier 406.

In some embodiments, the second static lighting item may further be a fireplace, a light bulb, a night pearl, a fire pile, or the like.

In some embodiments, a light range of the second static lighting item is greater than that of the first static lighting item, light brightness of the second static lighting item is greater than that of the first static lighting item, and an appearance probability of the second static lighting item is lower than that of the first static lighting item.

Manner 3: The main control virtual character carries a portable lighting item; and the portable lighting item is launched, in response to a launching operation of controlling the main control virtual character to launch the portable lighting item, to a first location to illuminate the second area, the second area being determined based on the first location and a lighting radius of the portable lighting item.

The portable lighting item is a lighting item that can continuously perform illumination. The portable lighting item is a throwing/launching-type item that is thrown/launched and used by the main control virtual character. After being thrown/launched, the portable lighting item may be fixed at a specified location and illuminate an area around the specified location. During being thrown, the portable lighting item may change a light form of an area of a flight path for a short time and change an interaction status of a photosensitive object near the flight path for a short time.

The portable lighting item may be an item automatically obtained after the main control virtual character enters the side-scrolling virtual environment. Alternatively, the portable lighting item may be an item obtained by the main control virtual character by completing a specified task in the side-scrolling virtual environment. Alternatively, the portable lighting item may be an item obtained after the main control virtual character kills a specified enemy.

The user controls the main control virtual character to launch the portable lighting item in a specified direction, and the launched portable lighting item may be attached to an environmental surface of the side-scrolling virtual environment, or the launched portable lighting item may hover at a specified location in the side-scrolling virtual environment.

In some embodiments, the portable lighting item has a farthest launching distance. If the portable lighting item hits the environmental surface before reaching the farthest launching distance, the portable lighting item is attached to the environmental surface. If the portable lighting item does not hit the environmental surface when reaching the farthest launching distance, the portable lighting item hovers at the farthest launching distance.

For example, the portable lighting item is launched in a direction indicated by the launching operation; and the portable lighting item is attached at the first location in response to that the portable lighting item is launched to the first location of the environmental surface; or

the portable lighting item is launched in a direction indicated by the launching operation; and the portable lighting item is suspended and fixed at the first location in response to that the portable lighting item does not collide with the environmental surface within the farthest launching distance, the first location being determined based on a location of the main control virtual character when the main control virtual character launches the portable lighting item, the direction indicated by the launching operation, and the farthest launching distance.

In some embodiments, the portable lighting item may further be retrieved after being launched; the main control virtual character is controlled to retrieve the portable lighting item in response to an operation of retrieving the portable lighting item; and the second area in the dark form is displayed in response to that the portable lighting item is retrieved. During being retrieved, the portable lighting item may change a light form of an area of a flight path for a short time and change an interaction status of a photosensitive object near the flight path for a short time.

In an embodiment, a light area around the main control virtual character is lit up by the portable lighting item. If the main control virtual character throws the portable lighting item, an area around the main control virtual character is plunged into darkness (displayed in the dark form), and the area around the main control virtual character remains to be displayed in the dark form before the portable lighting item is retrieved.

In some embodiments, the portable lighting item may be an energy light bulb. The energy light bulb may facilitate exploration in a later stage of a game when the main control virtual character repeatedly challenges a dark level, and avoid wasting time by the user. The energy light bulb may be obtained only after most dark areas are passed, and the main control virtual character may leave the energy light bulb at any location to shape the light area. The energy light bulb is a usable item.

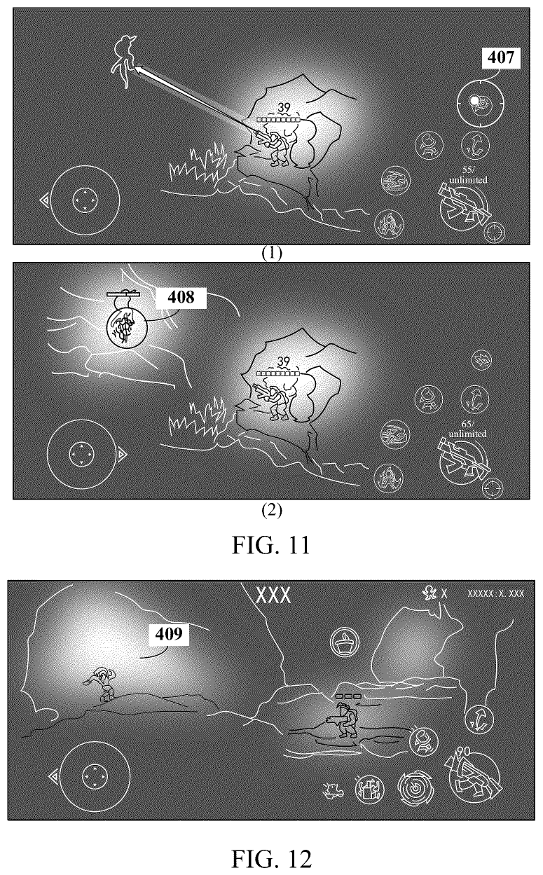

For example, as shown in FIG. 11(1), after the main control virtual character obtains the energy light bulb, a use control 407 for the energy light bulb is displayed on an interface. The user presses and holds the control 407 to summon a wheel. The user may control the wheel to aim in a direction and then loosen his/her hand, thereby controlling the main control virtual character to launch the energy light bulb in the aiming direction. As shown in FIG. 11(2), an energy light bulb 408 launched by the main control virtual character is attached to a wall surface of the side-scrolling virtual environment.

Manner 4: The side-scrolling virtual environment picture further includes a light-blocking object, and the light-blocking object is configured to block light; and the second area in the light form in the first area is displayed in response to that the main control virtual character destroys the light-blocking object, the second area being an area blocked by the light-blocking object.

Some areas in the side-scrolling virtual environment have own light. However, the areas may be blocked by the light-blocking object and be displayed in the dark form. If the main control virtual character destroys the light-blocking object, the areas may be re-displayed in the light form.

For example, that the light-blocking object is destroyed is displayed in response to that damage caused by the main control virtual character to the light-blocking object satisfies a threshold. Alternatively, that the light-blocking object is destroyed is displayed in response to that the main control virtual character treads on the light-blocking object.

In some embodiments, the light-blocking object may be a light-blocking stone. Some stones exist in the side-scrolling virtual environment, and the stones block illumination of light. The user needs to find the stones in the dark and destroy the stones, so that the light enters, to illuminate an area (the second area) in the side-scrolling virtual environment.

For example, as shown in FIG. 12, after the main control virtual character destroys the light-blocking stone blocking a second area 409, the second area 409 is displayed in the light form.

In conclusion, according to the method provided in this embodiment of this disclosure, a plurality of static lighting items, such as a match and a torch that are arranged on a wall surface or a road surface of the side-scrolling virtual environment, are arranged in the side-scrolling virtual environment. By approaching the static lighting item, the user may light the static lighting item, thereby illuminating the side-scrolling virtual environment in a specified range. A type of static lighting item (for example, the torch) is automatically extinguished after being lit for a period of time, and another type of static lighting item (for example, the brazier) permanently performs illumination after being lit. Lighting duration of a different lighting item is truly simulated.

According to the method provided in this embodiment of this disclosure, different static lighting items are arranged at a plurality of locations in the virtual environment, so that the main control virtual character may illuminate different areas in the side-scrolling virtual environment by using the lighting operation, to change interaction statuses of photosensitive objects in the different areas, and enrich the manner of interaction between the photosensitive object and the main control virtual character. The user may use the interaction statuses of the photosensitive objects in the different areas under different light levels to skillfully avoid an adverse factor in the side-scrolling virtual environment, quickly pass a level, and improve the strategy of the side-scrolling game.

According to the method provided in this embodiment of this disclosure, the main control virtual character carries the portable lighting item, so that the main control virtual character can autonomously create a light area in the side-scrolling virtual environment, thereby triggering a change in an interaction status of a photosensitive object in the area and improving efficiency of the user in changing the interaction status of the photosensitive object. In addition, after launching the portable lighting item, the main control virtual character may further retrieve the portable lighting item, so that the user continues to use the portable lighting item to respond to a subsequent level after passing through an unfavorable area.

According to the method provided in this embodiment of this disclosure, the light-blocking object is arranged in the side-scrolling virtual environment, and the main control virtual character may change a blocked area thereof into the light area by destroying the light-blocking object, thereby changing an interaction status of a photosensitive object in the area. A manner in which the main control virtual character changes the display form of the side-scrolling virtual environment is enriched.

For example, the photosensitive object provided in this embodiment of this disclosure may include a light-loving object.

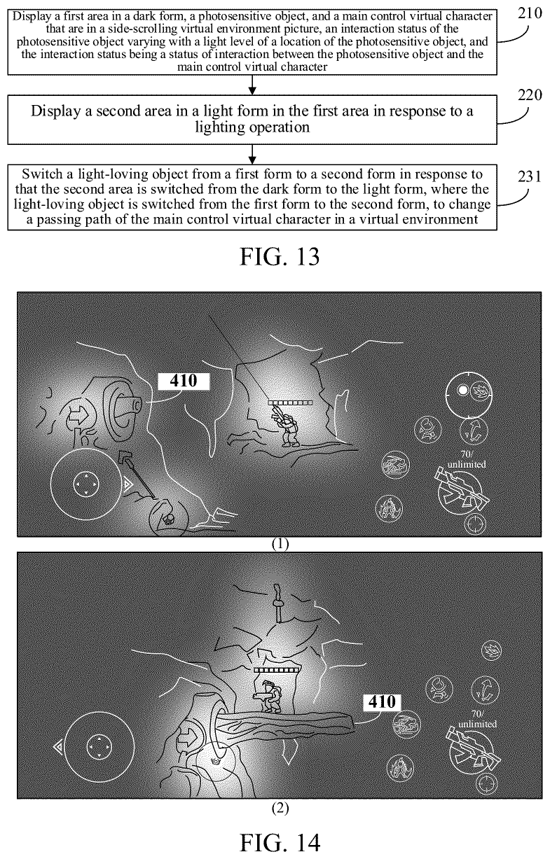

FIG. 13 is a flowchart of an interaction method based on a side-scrolling virtual environment according to an embodiment of this disclosure, and this embodiment is described by using an example in which the method is performed by the terminal (the first terminal or the second terminal)/the client shown in FIG. 1. Based on the embodiment shown in FIG. 3, operation 230 further includes operation 231.

Operation 210: Display a first area in a dark form, a photosensitive object, and a main control virtual character that are in a side-scrolling virtual environment picture, an interaction status of the photosensitive object varying with a light level of a location of the photosensitive object, and the interaction status being a status of interaction between the photosensitive object and the main control virtual character. For example, the virtual environment is displayed that includes a first area having an obscured visual state, an interactive object, and a virtual character controlled by a user. In an example, the first interaction state and the second interaction state defining different interactions with the virtual character.

The photosensitive object includes a light-loving object. The light-loving object is an object that likes light. For example, the light-loving object may be a light-loving plant or a device used by charging through solar energy. In a case that there is no light (a dark-form environment), the light-loving object is in a weak interaction state, and the light-loving object in the weak interaction state cannot interact with the main control virtual character, or a degree of interaction between the light-loving object in the weak interaction state and the main control virtual character is weak. In a case of being illuminated (a light-form environment), the light-loving object is in a strong interaction state, and the light-loving object in the strong interaction state can interact with the main control virtual character, or a degree of interaction between the light-loving object in the strong interaction state and the main control virtual character is strong.

The light-loving object in the dark-form environment is in a first form (a first interaction status). The first form (the first interaction status) may be: a non-battle state or a state of blocking a moving line. The light-loving object in the light-form environment is in a second form (a second interaction status). The second form (the second interaction status) may be: a battle state or a state of providing a moving line.

Operation 220: Display a second area in a light form in the first area in response to a lighting operation. For example, in response to a user input corresponding to an illumination action, a second area within the first area is modified to an unobscured visual state.

Operation 231: Switch the light-loving object from the first form to the second form in response to that the second area is switched from the dark form to the light form, where the light-loving object is switched from the first form to the second form, to change a passing path of the main control virtual character in a virtual environment. For example, the switching the light-sensitive object from the first interaction state to the second interaction state includes transitioning the light-seeking object from the first interaction state to the second interaction state in response to the second area being changed from the non-illuminated state to the illuminated state. The transition from the first interaction state to the second interaction state alters an available movement path for the virtual character in the virtual environment.

In one case, the light-loving object in the first form may block a moving line/movement path of the main control virtual character. The light-loving object in the second form may be in communication with the moving line/movement path of the main control virtual character, or provide the moving line/movement path for the main control virtual character.

In some embodiments, the light-loving object may be the light-loving plant. There are many plants that like light in the side-scrolling virtual environment. When the plants are exposed to light, the moving line is generated, to help the main control virtual character reach a place that cannot be reached in the dark. After the light disappears, the moving line disappears, and the light-loving plant shrinks back.

For example, as shown in FIG. 14(1), if the main control virtual character wants to reach a target point at an upper left corner, light needs to be given to a light-loving plant 410 that shrinks in a hole. After the light is given, as shown in FIG. 14(2), the light-loving plant 410 reaches out to help the main control virtual character generate a moving line in which the main control virtual character can walk, and then the main control virtual character can reach the upper left corner. FIG. 14 shows a transverse light-loving plant. In the side-scrolling virtual environment, an extension direction of the light-loving object is also annotated. For example, as shown in FIG. 14(1), an arrow pointing to the right is displayed alongside the light-loving plant 410. Apparently, the light-loving plant may alternatively be configured as a longitudinal or oblique light-loving plant. Alternatively, a transverse, longitudinal, or oblique light-phobic plant is configured.

In some embodiments, the light-loving object may be divided into the following types of light-loving objects based on a difference in the extension direction.

If the light-loving object includes a transverse light-loving object, the switching the light-loving object from the first form to the second form includes: transversely extending the transverse light-loving object to obtain a path for the main control virtual object to pass through;
and/or, if the light-loving object includes a longitudinal light-loving object, the switching the light-loving object from the first form to the second form includes: longitudinally extending the longitudinal light-loving object to obtain a path for the main control virtual object to pass through;
and/or, if the light-loving object includes an oblique light-loving object, the switching the light-loving object from the first form to the second form includes: obliquely extending the oblique light-loving object to obtain a path for the main control virtual object to pass through.

In some embodiments, a manner of determining whether the light-loving object receives a lighting event may be: determining a center point of the second area in response to that the second area is switched from the dark form to the light form; calculating a first distance between the light-loving object and the center point in the side-scrolling virtual environment picture; and switching the light-loving object from the first form to the second form in a case that the first distance is less than a first distance threshold, where the first distance threshold is determined based on a radius of the second area.

In some embodiments, the interaction status of the photosensitive object (the light-loving object) may be further determined based on a light level of a location of the photosensitive object (the light-loving object), where the light level is determined based on light source brightness and a distance between a current location and a light source. Larger brightness of the location of light-loving object indicates a larger degree of interaction (for example, a longer extension length or a faster attack speed) of the light-loving object.

For example, the photosensitive object (the light-loving object) corresponds to different extension lengths when being in different light levels; light source brightness of a light source in the second area is obtained; a third distance between the photosensitive object (the light-loving object) and the light source located in the second area is calculated; the light level is calculated based on the light source brightness, the third distance, and a distance attenuation parameter of brightness; a first extension length corresponding to the light level is obtained; and the photosensitive object (the light-loving object) is controlled to extend by the first extension length, where the extension length is positively correlated with the light level.

In conclusion, according to the method provided in this embodiment of this disclosure, a plurality of light-loving objects are arranged in the side-scrolling virtual environment. When the location of the light-loving object is switched from dark to light, the light-loving object is deformed, thereby generating a new movement path in the side-scrolling virtual environment for the main control virtual character to pass through. When the location of the light-loving object is switched from light to dark, the light-loving object is deformed again, and the movement path of the main control virtual character in the side-scrolling virtual environment is changed. In this way, the main control virtual character may change a light level of the location of the light-loving object, to change a movable path (the moving line) in the side-scrolling virtual environment, enrich a manner of interaction between the main control virtual character and the side-scrolling virtual environment, and improve strategy of a side-scrolling game.

For example, the photosensitive object provided in this embodiment of this disclosure may include a light-phobic object.

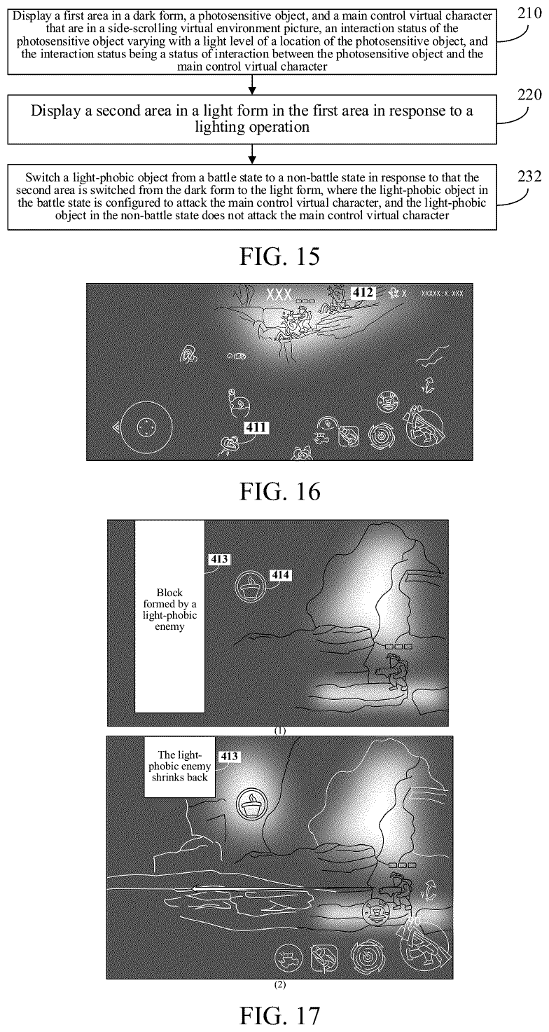

FIG. 15 is a flowchart of an interaction method based on a side-scrolling virtual environment according to an embodiment of this disclosure, and this embodiment is described by using an example in which the method is performed by the terminal (the first terminal or the second terminal)/the client shown in FIG. 1. Based on the embodiment shown in FIG. 3, operation 230 further includes operation 232.

Operation 210: Display a first area in a dark form, a photosensitive object, and a main control virtual character that are in a side-scrolling virtual environment picture, an interaction status of the photosensitive object varying with a light level of a location of the photosensitive object, and the interaction status being a status of interaction between the photosensitive object and the main control virtual character. For example, the virtual environment is displayed that includes a first area having an obscured visual state, an interactive object, and a virtual character controlled by a user. In an example, the first interaction state and the second interaction state defining different interactions with the virtual character.

The photosensitive object includes a light-phobic object. The light-phobic object is an object that fears light. For example, the light-phobic object may be a light-phobic plant or a light-phobic enemy. In a case that there is no light (a dark-form environment), the light-phobic object is in a strong interaction state, and the light-phobic object in the strong interaction state can interact with the main control virtual character, or a degree of interaction between the light-phobic object in the strong interaction state and the main control virtual character is strong. In a case of being illuminated (a light-form environment), the light-phobic object is in a weak interaction state, and the light-phobic object in the weak interaction state cannot interact with the main control virtual character, or a degree of interaction between the light-phobic object in the weak interaction state and the main control virtual character is weak.

The light-phobic object in the dark-form environment is in a first interaction status. The first interaction status may be: a battle state or a state of blocking a moving line. The light-phobic object in the light-form environment is in a second interaction status. The second interaction status may be: a non-battle state or a state of providing a moving line.

Operation 220: Display a second area in a light form in the first area in response to a lighting operation. For example, in response to a user input corresponding to an illumination action, a second area within the first area is modified to an unobscured visual state.

Operation 232: Switch the light-phobic object from the battle state to the non-battle state in response to that the second area is switched from the dark form to the light form, where the light-phobic object in the battle state is configured to attack the main control virtual character, and the light-phobic object in the non-battle state does not attack the main control virtual character. For example, the light-adverse object is transitioned from a battle state to a non-battle state in response to the second area being changed from the non-illuminated state to the illuminated state. In the battle state, the light-adverse object is configured to attack the virtual character. In the non-battle state, the light-adverse object does not attack the virtual character.

In some embodiments, there are many plants that fear light in the side-scrolling virtual environment. In the dark, the plants constantly perform an attack or block a road. When exposed to light, the plants fear the light, thereby stopping the attack or shrinking back and changing a blocked moving line into a walkable line. For example, as shown in FIG. 16, a plant 411 in the dark continuously performs an attack and releases a bullet, while a plant 412 exposed to light is dizzy and stops the attack.

In an implementation, the light-phobic object is switched from a third form to a fourth form in response to that the second area is switched from the dark form to the light form, where the light-phobic object is switched from the third form to the fourth form, to change a passing path of the main control virtual character in a virtual environment.

For example, the light-phobic object in the third form may block a moving line/movement path of the main control virtual character. The light-phobic object in the fourth form may stop blocking the moving line/movement path of the main control virtual character, or provide the moving line/movement path for the main control virtual character.

For example, a block formed by a light-phobic enemy may be arranged on a necessary road for the main control virtual character to block the moving line of the main control virtual character. In this case, a user needs to think how to generate light, to allow the light-phobic enemy to shrink back and allow the main control virtual character to pass. For example, as shown in FIG. 17(1), there is a light-phobic enemy 413 blocking a path (the moving line) for the main control virtual character to move ahead in the side-scrolling virtual environment. After the main control virtual character lights a torch 414, as shown in FIG. 17(2), the light-phobic enemy shrinks back, to expose the path for the main control virtual character to pass through, so that the main control virtual character can pass through.

In some embodiments, a manner of determining whether the light-phobic object receives a lighting event may be: determining a center point of the second area in response to that the second area is switched from the dark form to the light form; calculating a second distance between the light-phobic object and the center point in the side-scrolling virtual environment picture; and switching the light-phobic object from the battle state to the non-battle state in a case that the second distance is less than a second distance threshold, where the second distance threshold is determined based on a radius of the second area.

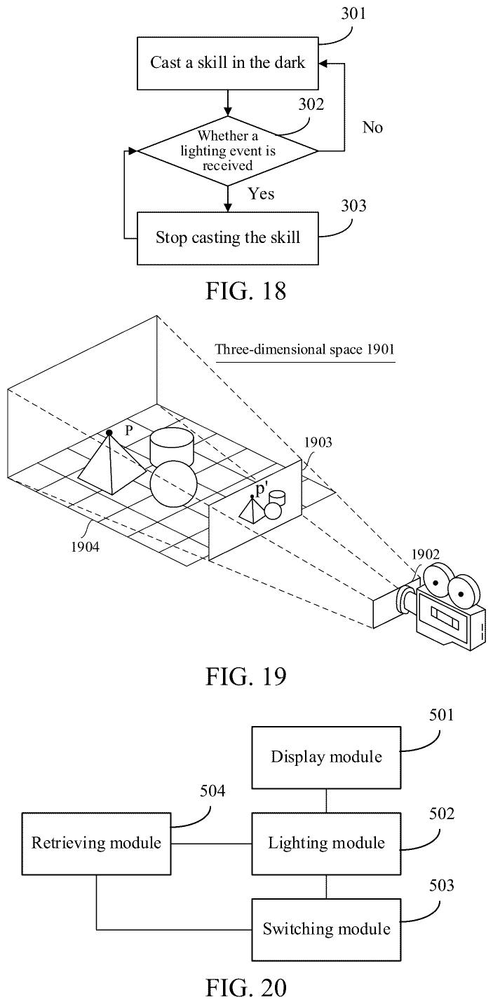

In some embodiments, as shown in FIG. 18, attack logic of the light-phobic object is as follows: Operation 301: Control the light-phobic object to cast a skill in the dark. Operation 302: Determine whether the light-phobic object receives a lighting event. If the lighting event is received, operation 303 is performed; otherwise, operation 301 is continuously performed. Operation 303: Control the light-phobic object to stop casting the skill.

In some embodiments, the interaction status of the photosensitive object (the light-phobic object) may be further determined based on a light level of the location of the photosensitive object (the light-phobic object), where the light level is determined based on light source brightness and a distance between a current location and a light source. Larger brightness of the location of the light-phobic object indicates a weaker degree of interaction (for example, changing a form of the light-phobic object, changing a light area, or a slower attack speed) of the light-phobic object.

For example, the photosensitive object (the light-phobic object) corresponds to different attack speeds and attack ranges when being in different light levels; light source brightness of a light source in the second area is obtained; a third distance between the photosensitive object (the light-phobic object) and the light source located in the second area is calculated; the light level is calculated based on the light source brightness, the third distance, and a distance attenuation parameter of brightness; a first attack speed and a first attack range corresponding to the light level are obtained; and the photosensitive object (the light-phobic object) is controlled to perform an attack at the first attack speed and the first attack range, where the attack speed and the attack range are negatively correlated with the light level.

In conclusion, according to the method provided in this embodiment of this disclosure, a plurality of types of light-phobic objects are arranged in the side-scrolling virtual environment, so that when the light-phobic object is in a dark area, the light-phobic object may continuously attack the main control virtual character, to hinder the main control virtual character from moving ahead. The main control virtual character may brighten the location of the light-phobic object, thereby controlling the light-phobic object to be switched to the non-battle state and stopping the attack of the light-phobic object on the main control virtual character, to facilitate the main control virtual character to pass through the area. This method enriches a manner of interaction between the main control virtual character and an enemy in the side-scrolling virtual environment. The main control virtual character can not only eliminate a blocking effect of the enemy by attacking the enemy, but also eliminate the blocking effect of the enemy by changing a light level of the side-scrolling virtual environment, thereby improving strategy of a side-scrolling game.

In an implementation, the side-scrolling virtual environment is an environment in which the virtual object is located in the side-scrolling virtual environment during running of an application program in the terminal. The side-scrolling virtual environment is three-dimensional space. A world space coordinate system is configured for describing coordinates of a three-dimensional model in the side-scrolling virtual environment in a same scene. The three-dimensional model is an object in the side-scrolling virtual environment.

For example, the world space coordinate system may be transformed from the three-dimensional model in a model space coordinate system by using a model transformation matrix. The model space coordinate system is configured for indicating location information of the three-dimensional model. Coordinate information of each three-dimensional model in the model space coordinate system is unified into the world space coordinate system in the three-dimensional space by using the model transformation matrix.

For example, the three-dimensional model in the world space coordinate system is transformed into a camera space coordinate system by using a view matrix. The camera space coordinate system is configured for describing coordinates of the three-dimensional model observed by using a camera model. For example, a location of the camera model is used as an origin of coordinates. The three-dimensional model of the camera space coordinate system is transformed into a cropping space coordinate system by using a projection matrix. The cropping space coordinate system is configured for describing a projection of the three-dimensional model in a viewing frustum of the camera model. A related perspective projection matrix (a projection matrix) is configured for projecting the three-dimensional model into a model that meets a “near-large, far-small” human eye observation rule. For example, the model transformation matrix, the view matrix, and the projection matrix are collectively referred to as model view projection (MVP) matrices.

FIG. 19 is a schematic diagram of a process of transforming three-dimensional space into a two-dimensional image according to an embodiment of this disclosure. With reference to FIG. 19, a process of mapping a feature point p in three-dimensional space 1901 to a feature point p′ in an imaging plane 1903 (an image coordinate system, or referred to as a pixel coordinate system) is shown. Coordinates of the feature point p in the three-dimensional space 1901 are in a three-dimensional form, and coordinates of the feature point p′ in the imaging plane 1903 are in a two-dimensional form. The three-dimensional space 1901 is three-dimensional space corresponding to a side-scrolling virtual environment. A camera plane 1902 is determined by a pose of a camera model. The camera plane 1902 is a plane perpendicular to a photographing direction of the camera model. An imaging plane 1903 and the camera plane 1902 are parallel to each other. The imaging plane 1903 is a plane of the side-scrolling virtual environment within a field of view during imaging by the camera model when the side-scrolling virtual environment is observed.

Further, the imaging plane 1903 and a reference plane 1904 are in a perpendicular relationship. A projection of the imaging plane 1903 on the reference plane 1904 is a straight line. An observation direction of a camera is perpendicular to the imaging plane 1903. In this figure, the reference plane 1904 is a horizontal plane in the three-dimensional space 1901. As a location of the camera model changes, the reference plane 1904 correspondingly changes to another plane. In the figure, it is only shown that at a current camera location, the reference plane 1904 is the horizontal plane in the three-dimensional space 1901. At the current camera location, the reference plane 1904 may alternatively be another plane parallel to the horizontal plane in the three-dimensional space 1901.

Further, in response to a touch operation on all or some of virtual objects on the imaging plane 1903, coordinates of the touch operation on the imaging plane 1903 are compared with mapping coordinates of the virtual object on the imaging plane 1903, to touch and operate the corresponding virtual object.

FIG. 20 is a structural block diagram of an interaction apparatus based on a side-scrolling virtual environment according to an embodiment of this disclosure. The apparatus includes:
a display module 501, configured to perform operation 110 in the embodiment in FIG. 2;
a lighting module 502, configured to perform operation 120 in the embodiment in FIG. 2; and
a switching module 503, configured to perform operation 130 in the embodiment in FIG. 2.

In an embodiment, the display module 501 is configured to perform operation 210 in the embodiment in FIG. 3.

In an embodiment, the lighting module 502 is configured to perform operation 220 in the embodiment in FIG. 3.

In an embodiment, the switching module 503 is configured to perform operation 230 in the embodiment in FIG. 3.

In an embodiment, the photosensitive object includes a light-loving object located in the second area.

The switching module 503 is configured to perform operation 231 in the embodiment in FIG. 3.

In an embodiment, the light-loving object includes a transverse light-loving object; and the switching module 503 is configured to perform operation 231 in the embodiment in FIG. 3.

The light-loving object includes a longitudinal light-loving object; and the switching module 503 is configured to perform operation 231 in the embodiment in FIG. 3.

The light-loving object includes an oblique light-loving object; and the switching module 503 is configured to perform operation 231 in the embodiment in FIG. 3.

In an embodiment, the switching module 503 is configured to: determine a center point of the second area in response to that the second area is switched from the dark form to the light form; and
the switching module 503 is configured to perform operation 231 in the embodiment in FIG. 3.

The switching module 503 is configured to perform operation 231 in the embodiment in FIG. 3.

In an embodiment, the photosensitive object includes a light-phobic object located in the second area; and
the switching module 503 is configured to perform operation 232 in the embodiment in FIG. 3.

In an embodiment, the switching module 503 is configured to perform operation 232 in the embodiment in FIG. 3.

The switching module 503 is configured to perform operation 232 in the embodiment in FIG. 3.

The switching module 503 is configured to perform operation 232 in the embodiment in FIG. 3.

In an embodiment, the side-scrolling virtual environment picture further includes a first static lighting item; and
the lighting module 502 is configured to perform operation 220 in the embodiment in FIG. 3.

In an embodiment, the side-scrolling virtual environment picture further includes a second static lighting item; and
the lighting module 502 is configured to perform operation 220 in the embodiment in FIG. 3.

In an embodiment, the main control virtual character carries a portable lighting item; and
the lighting module 502 is configured to perform operation 220 in the embodiment in FIG. 3.

In an embodiment, the lighting module 502 is configured to perform operation 220 in the embodiment in FIG. 3.

In an embodiment, the apparatus further includes: a retrieving module 504, configured to perform operation 220 in the embodiment in FIG. 3.

The display module 501 is configured to perform operation 220 in the embodiment in FIG. 3.

In an embodiment, the side-scrolling virtual environment picture further includes a light-blocking object, and the light-blocking object is configured to block light; and
the lighting module 502 is configured to perform operation 220 in the embodiment in FIG. 3.

In an embodiment, the apparatus further includes: the switching module 503 is configured to perform operation 230 in the embodiment in FIG. 3.

In an embodiment, the switching module 503 is configured to perform operation 231 in the embodiment in FIG. 3.

The switching module 503 is configured to perform operation 231 in the embodiment in FIG. 3.

The switching module 503 is configured to perform operation 231 in the embodiment in FIG. 3.

The switching module 503 is configured to perform operation 231 in the embodiment in FIG. 3.

The switching module 503 is configured to perform operation 232 in the embodiment in FIG. 3.

The switching module 503 is configured to perform operation 232 in the embodiment in FIG. 3.

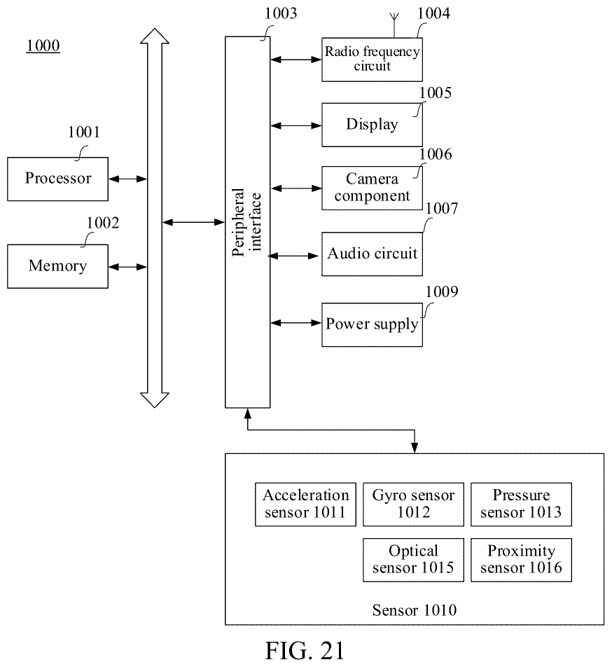

FIG. 21 is a structural block diagram of a computer device 1000 according to an embodiment of this disclosure. The computer device 1000 may be a portable mobile terminal, for example, a smartphone, a tablet computer, a moving picture experts group audio layer III (MP3) player, a moving picture experts group audio layer IV (MP4) player, a notebook computer, or a desktop computer. The computer device 1000 may be further referred to as another name such as user equipment, a portable terminal, a laptop terminal, or a desktop terminal.

The computer device 1000 includes a processor 1001 (e.g., processing circuitry) and a memory 1002 (e.g., a non-transitory computer-readable storage medium).

The processor 1001 may include one or more processing cores, and may be, for example, a 4-core processor or an 8-core processor. The processor 1001 may be implemented in at least one hardware form of digital signal processing (DSP), a field-programmable gate array (FPGA), and a programmable logic array (PLA). The processor 1001 may alternatively include a main processor and a coprocessor. The main processor is configured to process data in an active state, and is also referred to as a central processing unit (CPU); and the coprocessor is a low-power processor configured to process data in a standby state. In some embodiments, the processor 1001 may be integrated with a graphics processing unit (GPU). The GPU is configured to render and draw content that needs to be displayed on a display. In some embodiments, the processor 1001 may further include an artificial Intelligence (AI) processor. The AI processor is configured to process a computing operation related to machine learning.

The memory 1002 may include one or more computer-readable storage media that may be non-transitory. The memory 1002 may further include a high-speed random access memory and a non-volatile memory, for example, one or more disk storage devices or flash storage devices. In some embodiments, the non-transitory computer-readable storage medium in the memory 1002 is configured to store at least one instruction, and the at least one instruction is configured to be executed by the processor 1001 to implement the virtual object skill release method according to the method embodiments in this disclosure.

In some embodiments, the computer device 1000 further includes a peripheral interface 1003 and at least one peripheral. The processor 1001, the memory 1002, and the peripheral interface 1003 may be connected through a bus or a signal cable. Each peripheral may be connected to the peripheral interface 1003 through a bus, a signal cable, or a circuit board. For example, the peripheral includes: at least one of a radio frequency circuit 1004, a display screen 1005, a camera component 1006, an audio circuit 1007, and a power supply 1009.

In some embodiments, the computer device 1000 further includes one or more sensors 1010. The one or more sensors 1010 include, but are not limited to, an acceleration sensor 1011, a gyroscope sensor 1012, a pressure sensor 1013, an optical sensor 1015, and a proximity sensor 1016.

A person skilled in the art may understand that the structure shown in FIG. 21 does not constitute any limitation on the computer device 1000, and the computer device may include more components or fewer components than those shown in the figure, or some components may be combined, or a different component deployment may be used.

This disclosure further provides a computer-readable storage medium, such as a non-transitory computer-readable storage medium, having at least one instruction, at least one program, a code set or an instruction set stored therein, where the at least one instruction, the at least one program, the code set or the instruction set being loaded and executed by a processor to implement the interaction method based on a side-scrolling virtual environment according to the foregoing method embodiments.

This disclosure provides a computer program product or a computer program, the computer program product or the computer program including computer instructions, the computer instructions being stored in a computer-readable storage medium. A processor of a computer device reads the computer instructions from the computer-readable storage medium, and executes the computer instructions, causing the computer device to perform the interaction method based on a side-scrolling virtual environment according to the foregoing method embodiments.

What is claimed is:

1. A method for interacting in a virtual environment, comprising:
displaying the virtual environment that includes a first area having an obscured visual state, an interactive object, and a virtual character controlled by a user;
in response to a user input corresponding to an illumination action, modifying a second area within the first area to an unobscured visual state;
determining whether the interactive object is located within the second area; and
changing an interaction state of the interactive object from a first interaction state to a second interaction state based on the interactive object being determined to be located within the second area, the first interaction state and the second interaction state defining different interactions with the virtual character.

2. The method according to claim 1, wherein the obscured visual state includes a non-illuminated state, the unobscured visual state includes an illuminated state, and the interactive object includes a light-sensitive object; and
wherein the changing the interaction state of the interactive object comprises:
in response to the second area changing from the non-illuminated state to the illuminated state, switching the light-sensitive object from the first interaction state to the second interaction state.

3. The method according to claim 2, wherein
the light-sensitive object comprises a light-seeking object;
the switching the light-sensitive object from the first interaction state to the second interaction state includes transitioning the light-seeking object from the first interaction state to the second interaction state in response to the second area being changed from the non-illuminated state to the illuminated state; and
the transition from the first interaction state to the second interaction state alters an available movement path for the virtual character in the virtual environment.

4. The method according to claim 3, wherein the light-seeking object comprises at least one of:
a horizontal light-seeking object that is configured to extend in a horizontal direction to create a horizontal path for the virtual character in the second interaction state;
a vertical light-seeking object that is configured to extend in a vertical direction to create a vertical path for the virtual character in the second interaction state; or
an oblique light-seeking object that is configured to extend in an oblique direction to create an oblique path for the virtual character in the second interaction state.

5. The method according to claim 3, wherein the transitioning the light-seeking object from the first interaction state to the second interaction state comprises:
determining a central point of the second area when the second area changes from the non-illuminated state to the illuminated state;
calculating a distance between the light-seeking object and the central point in the virtual environment; and
transitioning the light-seeking object from the first interaction state to the second interaction state when the calculated distance is less than a first threshold distance.

6. The method according to claim 2, wherein
the light-sensitive object includes a light-adverse object;
the switching the light-sensitive object from the first interaction state to the second interaction state comprises:
transitioning the light-adverse object from a battle state to a non-battle state in response to the second area being changed from the non-illuminated state to the illuminated state;
in the battle state, the light-adverse object is configured to attack the virtual character; and
in the non-battle state, the light-adverse object does not attack the virtual character.

7. The method according to claim 6, wherein the transitioning the light-adverse object from the battle state to the non-battle state comprises:
determining a central point of the second area when the second area changes from the non-illuminated state to the illuminated state;
calculating a distance between the light-adverse object and the central point in the virtual environment; and
transitioning the light-adverse object from the battle state to the non-battle state when the calculated distance is less than a second threshold distance.

8. The method according to claim 1, wherein
the unobscured visual state includes an illuminated state; and
the modifying the second area within the first area to the unobscured visual state comprises:
displaying the second area in the illuminated state in response to the illumination action.

9. The method according to claim 8, wherein
the virtual environment further includes a first static light source object;
the displaying the second area in the illuminated state includes activating the first static light source object to illuminate the second area when a distance between the virtual character and the first static light source object are less than a first threshold;
the second area is determined based on a location of the first static light source object and a predefined illumination radius of the first static light source object; and
an illumination duration of the first static light source object after activation is a first duration.

10. The method according to claim 8, wherein
the virtual environment further includes a second static light source object;
the displaying the second area in the illuminated state includes activating the second static light source object to illuminate the second area when a distance between the virtual character and the second static light source object are less than a second threshold;
the second area is determined based on a location of the second static light source object and a predefined illumination radius of the second static light source object; and
the second static light source object remains activated after being activated.

11. The method according to claim 8, wherein
the virtual character carries a movable light source object; and
the displaying the second area in the illuminated state in the first area includes launching the movable light source object to a target location in response to a launch command input for the virtual character; and
the second area is determined based on the target location and a predefined illumination radius of the movable light source object.

12. The method according to claim 11, wherein the launching the movable light source object comprises:
launching the movable light source object in a direction indicated by the launch command input; and
at least one of
attaching the movable light source object at the target location when the movable light source object contacts an environmental surface; or
maintaining the movable light source object at the target location when the movable light source object does not contact the environmental surface within a maximum launch distance, the target location being determined based on an initial position of the virtual character when the movable light source object is launched, the direction indicated by the launch command input, and one of a point of contact with the environmental surface or the maximum launch distance.

13. The method according to claim 11, further comprising:
controlling the virtual character to retrieve the movable light source object in response to a retrieval command input; and
updating the second area to revert from the illuminated state to the obscured visual state.

14. The method according to claim 8, wherein
the virtual environment further includes a light-blocking object that is configured to obstruct light; and
the displaying the second area in the illuminated state includes displaying the second area in the illuminated state when the light-blocking object is removed from the virtual environment, the second area corresponding to an area previously obstructed by the light-blocking object.

15. The method according to claim 2, further comprising:
detecting a change in the second area from the illuminated state back to the non-illuminated state; and
in response to the change, switching the light-sensitive object in the second area from the second interaction state to the first interaction state.

16. The method according to claim 2, further comprising:
determining the interaction state of the light-sensitive object based on a light intensity level at a location of the light-sensitive object in the virtual environment, the light intensity level being based on a brightness value of a light source, and a distance between the light-sensitive object and the light source.

17. The method according to claim 16, wherein
the light-sensitive object is associated with different attack speeds and attack ranges for different light intensity levels;
the determining the interaction state of the light-sensitive object based on the light intensity level comprises:
obtaining the brightness value of the light source in the second area;
calculating a distance between the light-sensitive object and the light source;
calculating the light intensity level based on the brightness value, the distance, and a light attenuation factor;
determining an attack speed and an attack range corresponding to the calculated light intensity level;
controlling the light-sensitive object to perform an attack according to the determined attack speed and attack range; and
the attack speed and the attack range are inversely correlated with the light intensity level.

18. An apparatus, comprising:
processing circuitry configured to:
display a virtual environment that includes a first area having an obscured visual state, an interactive object, and a virtual character controlled by a user;
in response to a user input corresponding to an illumination action, modify a second area within the first area to an unobscured visual state;
determine whether the interactive object is located within the second area; and
change an interaction state of the interactive object from a first interaction state to a second interaction state based on the interactive object being determined to be located within the second area, the first interaction state and the second interaction state defining different interactions with the virtual character.

19. The apparatus according to claim 18, wherein
the obscured visual state includes a non-illuminated state, the unobscured visual state includes an illuminated state, and the interactive object includes a light-sensitive object; and
the processing circuitry is configured to:
in response to the second area changing from the non-illuminated state to the illuminated state, switch the light-sensitive object from the first interaction state to the second interaction state.

20. A non-transitory computer-readable storage medium, storing instructions which when executed by a processor cause the processor to perform:
displaying a virtual environment that includes a first area having an obscured visual state, an interactive object, and a virtual character controlled by a user;
in response to a user input corresponding to an illumination action, modifying a second area within the first area to an unobscured visual state;
determining whether the interactive object is located within the second area; and
changing an interaction state of the interactive object from a first interaction state to a second interaction state based on the interactive object being determined to be located within the second area, the first interaction state and the second interaction state defining different interactions with the virtual character.
